(19) United States
(12) Patent Application Publication
(10) Pub. No.: US 2026/0111747 A1
(43) Pub. Date: Apr. 23, 2026

(54) METHOD AND SYSTEM FOR MULTI-OBJECTIVE AND TIME INFERENCE ALIGNMENTS OF LARGE LANGUAGE MODELS BASED ON AUTOREGRESSIVE REWARD MODELS

(71) Applicant: JPMorgan Chase Bank, N.A., New York, NY (US)

(72) Inventors: Yuancheng XU, Greenbelt, MD (US); Udari Madhushani SEHWAG, Jersey City, NJ (US); Alec KOPPEL, New York, NY (US); Sumitra GANESH, Short Hills, NJ (US)

(73) Assignee: JPMorgan Chase Bank, N.A., New York, NY (US)

(21) Appl. No.: 18/924,602

(22) Filed: Oct. 23, 2024

(51) Int. Cl. G06N 3/092; G06N 3/045

(52) U.S. Cl. CPC G06N 3/092; G06N 3/045

(57) ABSTRACT

A method and system for generating a response to a user prompt may be provided. The method may include obtaining the user prompt comprising the at least one objective and the at least one user preference dimension. The method may include performing an inference of the user prompt via the combination ML model, the combination ML model may include a base large language model (LLM) and at least one autoregressive reward model (ARM). The method may include generating the response corresponding to the at least one objective correlating with the at least one user preference dimension via the combination ML model.

### FIELD OF THE DISCLOSURE

This technology generally relates to methods and systems for multi-objective and time inference alignments of large language models based on autoregressive reward models.

### BACKGROUND INFORMATION

Large language models (LLMs), trained on extensive datasets, exhibit impressive versatility across numerous tasks. However, their outputs often fail to align with user preferences in terms of the kinds of response that the user would like to get. Indeed, current training-based alignment methods for LLMs face several challenges: computational bottlenecks, limited control when multiple objectives are desired, lack of flexibility over multi-dimensional preference, time inference issues involving inefficient generation of next token rewards during training, and requiring repeated re-training of the LLMs.

These challenges prevent the LLMs from efficiently meeting the needs of the user in terms of achieving the response to a query that the user desires. Additionally, the present challenges of requiring retraining of the LLMs each time that the user wishes to update the response to better align with the user's desires and objective results in high computational costs because retraining of the LLMs is a computationally intensive and tedious process. Indeed, necessitating retraining of the LLM each time the user's desires or needs changes is highly inefficient.

Accordingly, there is a need for techniques to generate a response to a user prompt based on alignments of LLMs via auto-regressive techniques.

### SUMMARY

The present disclosure, through one or more of its various aspects, embodiments, and/or specific features or sub-components, provides, inter alia, various systems, servers, devices, methods, media, programs, and platforms for generating a response to a user prompt via multi-objective and time inference alignments of large language models (LLMs) based on auto-regressive reward models (ARMs).

According to an aspect of the present disclosure, a method for generating a response corresponding to at least one objective aligned with at least one user preference dimension in real-time by a combination machine learning (ML) model may be provided. The method may be implemented by at least one processor. The method may include obtaining the user prompt comprising the at least one objective and the at least one user preference dimension; and performing an inference of the user prompt via the combination ML model. The combination ML model may include a base large language model (LLM) and at least one autoregressive reward model (ARM). The method may further include generating the response corresponding to the at least one objective correlating with the at least one user preference dimension via the combination ML model.

The combination ML model may be trained based on a predetermined training procedure that may include an alignment of the base LLM with the at least one user preference dimension via the at least one ARM by: obtaining training data with the at least one user preference dimension; and training the at least one ARM based on a controlled decoding process with a negative log-likelihood loss function analyzing tokens derived from the training data. The predetermined training procedure may further include generating next-level token rewards via the at least one ARM; and aligning the base LLM by combining predictive logits of the base LLM with a linear combination of the next-level token rewards from the trained at least one ARM. The predetermined training procedure may further include selecting a next token, via the aligned base LLM, that meets a predetermined threshold correlating with the at least one user preference dimension; and generating the at least one objective response based on the selected next token.

The predetermined training procedure may further include adjusting the linear combination of the next-level token rewards associated with the one user preference dimension as generated via the at least one ARM by adjusting the controlled decoding process; and re-aligning the base LLM via the least one ARM based on the adjusting.

The predetermined training procedure may further include analyzing a partial response via the at least one ARM; and predicting the next-level token rewards based on a result of the analyzing of the partial response.

A change from the at least one user preference dimension to at least one other user preference dimension may include a retraining of the at least one ARM by the predetermined training procedure without a retraining of the base LLM.

The at least one objective may include at least one from among a client production/use objective, an educational objective, and a software testing/development objective. The at least one user preference dimension may include at least one from among clarity, helpfulness, and level of detail. The at least one ARM may include a first ARM and a second ARM.

According to another embodiment, a computing apparatus for generating a response corresponding to at least one objective aligned with at least one user preference dimension in real-time by a combination machine learning (ML) model may be provided. The computing apparatus may include: a processor; a memory; a display; and a communication interface coupled to each of the processor, the memory, and the display.

The processor may be configured to: obtain the user prompt comprising the at least one objective and the at least one user preference dimension; and perform an inference of the user prompt via the combination ML model. The combination ML model may include a base LLM and at least one ARM. The processor may be further configured to generate the response corresponding to the at least one objective correlating with the at least one user preference dimension via the combination ML model.

The processor may be further configured to train the combination ML model based on performing a predetermined training procedure that may include an alignment of the base LLM with the at least one user preference dimension via the at least one ARM by: obtaining training data with the at least one user preference dimension; and training the at least one ARM based on a controlled decoding process with a negative log-likelihood loss function analyzing tokens derived from the training data. The processor may be further configured to perform the predetermined training procedure by: generating next-level token rewards via the at least one ARM; and aligning the base LLM by combining predictive logits of the base LLM with a linear combination of the next-level token rewards from the trained at least one ARM. The processor may be further configured to perform the predetermined training procedure by selecting a next token, via the aligned base LLM, that meets a predetermined threshold correlating with the at least one user preference dimension; and generating the at least one objective response based on the selected next token.

The processor may be further configured to perform the predetermined training procedure by: adjusting the linear combination of the next-level token rewards associated with the one user preference dimension as generated via the at least one ARM by adjusting the controlled decoding process; and re-aligning the base LLM via the least one ARM based on the adjusting.

The processor may be further configured to perform the predetermined training procedure by: analyzing a partial response via the at least one ARM; and predicting the next-level token rewards based on a result of the analyzing of the partial response.

A change from the at least one user preference dimension to at least one other user preference dimension may include a retraining of the at least one ARM by the predetermined training procedure without a retraining of the base LLM.

The at least one objective may include at least one from among a client production/use objective, an educational objective, and a software testing/development objective. The at least one user preference dimension may include at least one from among clarity, helpfulness, and level of detail. The at least one ARM may include a first ARM and a second ARM.

According to yet another embodiment, a method for training a combination machine learning model to generate a response corresponding to at least one objective aligned with at least one user preference dimension in real-time may be provided. The method may be implemented by at least one processor. The method may include training the combination machine learning (ML) model comprising a base large language model (LLM) and at least one autoregressive reward model (ARM) based on a predetermined training procedure; and performing the predetermined training procedure that aligns the base LLM with the at least one user preference dimension via the at least one ARM.

The performing the predetermined training procedure may include obtaining training data with the at least one user preference dimension; and training the at least one ARM based on a controlled decoding process with a negative log-likelihood loss function analyzing tokens derived from the training data. The performing the predetermined training procedure may further include generating next-level token rewards via the at least one ARM; and aligning the base LLM by combining predictive logits of the base LLM with a linear combination of the next-level token rewards from the trained at least one ARM. The performing the predetermined training procedure may further include selecting a next token, via the aligned base LLM, that meets a predetermined threshold correlating with the at least one user preference dimension; and generating the at least one objective response based on the selected next token.

The performing the predetermined training procedure may further include adjusting the linear combination of the next-level token rewards associated with the one user preference dimension as generated via the at least one ARM by adjusting the controlled decoding process; and re-aligning the base LLM via the least one ARM based on the adjusting.

The performing the predetermined training procedure may further include analyzing a partial response via the at least one ARM; and predicting the next-level token rewards based on a result of the analyzing of the partial response.

A change from the at least one user preference dimension to at least one other user preference dimension may include a retraining of the at least one ARM by the predetermined training procedure without a retraining of the base LLM.

The method may further include obtaining the user prompt comprising the at least one objective and the at least one user preference dimension; performing an inference of the user prompt via the combination ML model; and generating the response corresponding to the at least one objective correlating with the at least one user preference dimension via the combination ML model.

The at least one objective may include at least one from among a client production/use objective, an educational objective, and a software testing/development objective.

The at least one user preference dimension may include at least one from among clarity, helpfulness, and level of detail.

The at least one ARM may include a first ARM and a second ARM.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for generating a response to a user prompt via multi-objective and time inference alignments of large language models (LLMs) based on autoregressive models (ARMs).

FIG. 4 illustrates a flowchart of a process diagram according to an embodiment for generating a response to a user prompt based on multi-objective and time inference alignments of LLMs based on ARMs.

FIG. 5 illustrates examples of different LLM capabilities on multiple dimensions according to an embodiment.

FIG. 6 illustrates an example of a reward-guided generation approach according to an embodiment.

FIG. 7 illustrates an example of a traditional trajectory-level reward model.

FIG. 8 illustrates an example controlled decoding approach according to an embodiment.

FIG. 9 illustrates an example of generating a next token reward and next token sampling for an ARM according to an embodiment.

FIG. 10 illustrates an example training procedure for the ARM with and for learning to predict token-level reward from partial responses according to an embodiment.

FIG. 11 illustrates an example ARM trained in harmlessness and helpfulness based on response results according to an embodiment.

FIG. 12 illustrates experimental results of an ARM trained in harmlessness and helpfulness according to an embodiment.

### DETAILED DESCRIPTION

Large language models (LLMs), trained on extensive datasets, exhibit impressive versatility across numerous tasks. However, their outputs often fail to align with user preferences in terms of the kinds of response that the user would like to get. Indeed, current training-based alignment methods for LLMs face several challenges: computational bottlenecks, limited control when multiple objectives are desired, lack of flexibility over multi-dimensional preference, time inference issues involving inefficient generation of next token rewards during training, and requiring repeated retraining of the LLMs.

Computational bottlenecks may involve traditional training-based alignment methods, such as Reinforcement Learning from Human Feedback (RLHF), which are computationally intensive. This may especially be the case when utilizing traditional RLHF techniques in adapting large-scale LLMs to new or evolving user references. Indeed, RLHF techniques alone has significant alignment costs because they are computationally expensive, particularly for large-scale LLMs. Thus, while RLHF may enhance the LLM's relevance, the computational costs for aligning with different preferences may be high due to the computational resources needed to make such alignments.

Limited control over multi-objective alignment, i.e., limited control when multiple objectives are desired, may be present with current alignment techniques. This is because current alignment techniques often rely on simplistic labels to represent user preferences and thus, typically capturing only an average preference without addressing the complexities of multi-dimensional user values. This may then result in a rigid, single-model approach that fails to adapt to the varied and sometimes conflicting preferences across different user groups, such as balancing helpfulness with harmlessness. Indeed, adjusting LLMs to emerging user preferences or evolving datasets necessitates retraining with new preference datasets, which further increases computational and operational burdens.

Inefficiency in managing multi-dimensional preferences, i.e., lack of flexibility over multi-dimensional preference, may be present when explicitly managing multiple preference dimensions with training-based methods. This because such management may require repeated retraining for each unique trade-off, making the management process not only computationally expensive, but also less adaptable to real-time needs.

Inference challenges, i.e., time inference issues involving inefficient generation of next token rewards during training, may also be present during training. Test-time alignment methods that utilizes traditional trajectory-level reward models, which does not provide next-token rewards, making the generation of next tokens inefficient because they do not account for the prediction of next-level tokens.

These challenges prevent the LLMs from efficiently meeting the needs of the user in terms of achieving the response to a query that the user desires. Additionally, the present challenges of requiring retraining of the LLMs each time that the user wishes to update the response to better align with the user's desires and objective results in high computational costs because retraining of the LLMs is a computationally intensive and tedious process. Indeed, necessitating retraining of the LLM each time the user's desires or needs changes is highly inefficient.

Traditional alignment techniques may be broadly categorized into training-based and test-time approaches. An example of training-time approach may be Reinforcement Learning from Human Feedback (RLHF) that may involve learning a reward model from human preference datasets and then fine-tuning a language model (e.g., a LLM) to maximize these rewards. While RLHF may be effective at aligning outputs with user preferences, RLHF is limited to predefined preferences and lacks the flexibility to adapt during deployment. Thus, RLHF may be utilized in conjunction with Direct Preference Optimization (DPO), which may provide a simplification of a fine-tuning the LLM directly on preference datasets, eliminating the need for a separate reward model, but DPO similarly struggles to adjust to evolving preferences in real-time.

Traditional test-time alignment approach may typically employ Trajectory-Level Reward Models to guide the base LLM's generation. For instance, these approaches may involve generating next-token rewards by evaluating incomplete or fully rolled-out responses using trajectory-level models. However, these traditional approaches are computationally expensive and inefficient for partial responses.

In contrast to these traditional alignment techniques, the present application discloses Autoregressive Reward Model (ARM), which may directly learn token-level rewards from preference datasets. Thus, enabling more efficient and more precise guided decoding without the need for additional training or the high inference costs of traditional methods.

The present application provides a technological improvement of the status quo because no retraining of the LLM is needed for multi-objective alignment (e.g., based on the user's preferences) and time inference alignment (e.g., based on a time an inference is made). Instead, autoregressive reward models (ARMs) may be trained to meet these multi-objectives and time inference alignments and then guide the LLMs by aligning them based on token-level rewards associated with such multi-objective and time inference alignments.

That is, to address these challenges in the status quo, the ARM may be utilized in conjunction with the LLMs. The ARM enables efficient alignments by being trained to reflect user preferences and are then utilized to guide the text generation of a base LLM. This technique provides a technological improvement to the technique field of LLMs and their training by: eliminating the need to retrain the base LLM (thus, reducing the computational costs), and enhancing flexibility and adaptability of the base LLM by facilitating quick alignment of the base LLM to different user preferences without additional training. Moreover, ARM provides token-level reward signals, thereby enabling more efficient generation of next-tokens compared with prior test-time alignment approaches.

Furthermore, the utilization of ARM as described in the present application leverages reward mechanisms specifically trained to reflect diverse user preferences, thus guiding the text generation of a base LLM during inference stages. Compared to traditional trajectory-level reward models, ARM offers the significant advantage of providing token-level reward signals, which allows for more precise and responsive control over the generated content, i.e., generated response to the user's query. This approach not only reduces training costs by avoiding retraining of the base LLM. As stated above, this provides enhanced flexibility by enabling the quick alignment of various base LLMs to different preferences without the need for additional training. Moreover, ARM's ability to adjust the influence of different rewards dynamically during inference facilitates efficient and fine-grained control over multiple preference dimensions, thus providing a more nuanced and adaptable solution for multi-objective alignment in LLMs.

Accordingly, the present application provides technological improvements by eliminating the need for computationally intensive LLM retraining of the base LLM. Instead, the ARM may be trained for each preference dimension. These ARMs may then be utilized to guide the decoding process of the base LLM to align the base LLM to the desired preference dimension, thus ensuring efficient and targeted alignment with multi-dimensional preferences. It is noted that the terms LLM and base LLMs may be used interchangeably. Further details of the present application are provided below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

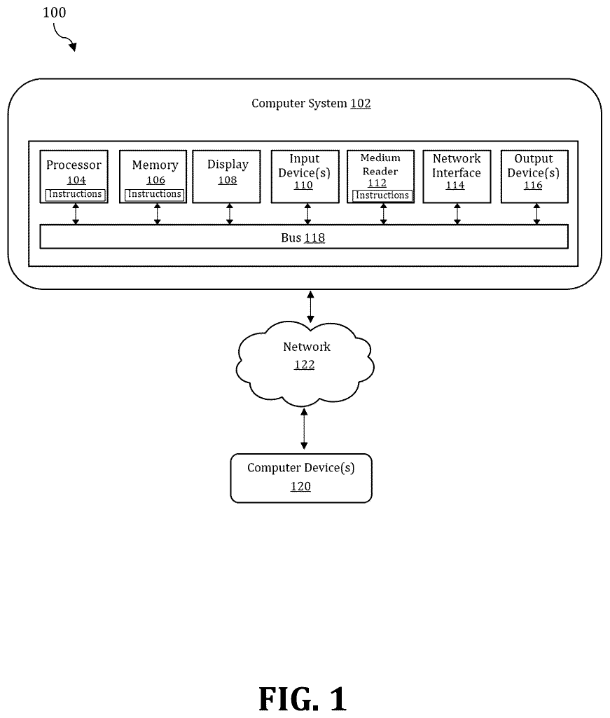

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for generating a response to a user prompt via multi-objective and time inference alignments of large language models (LLMs) based on auto-regressive reward models (ARMs).

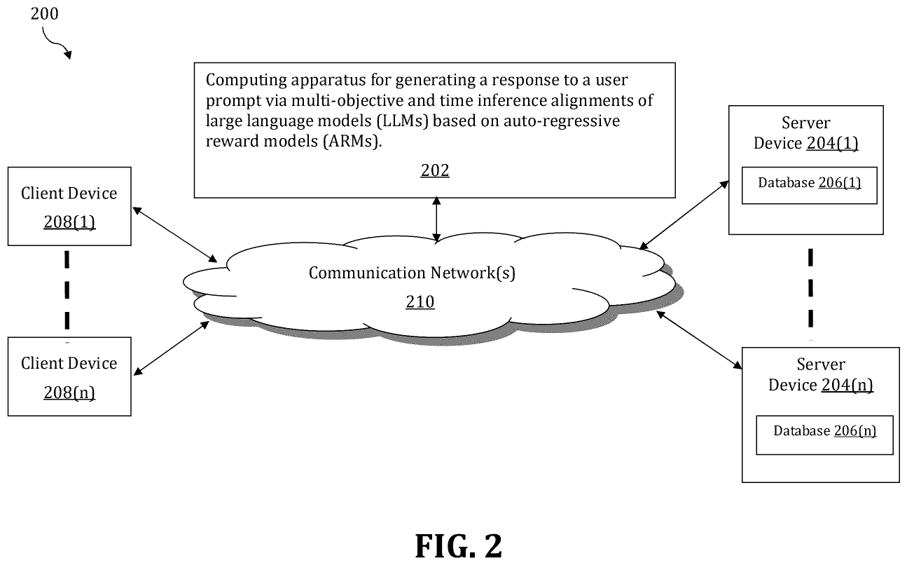

Referring to FIG. 2, a network diagram of a network environment 200 for generating a response to a user prompt via multi-objective and time inference alignments of LLMs based on ARMs may be illustrated. In an embodiment, the method may be executable on any networked computer platform, such as, for example, a personal computer (PC).

The method for generating a response to a user prompt via multi-objective and time inference alignments of LLMs based on ARMs may be implemented by a computing apparatus 202 that implement a generation a response to a user prompt via multi-objective and time inference alignments of LLMs based on ARMs. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for generating a response to a user prompt via multi-objective and time inference alignments of LLMs based on ARMs.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

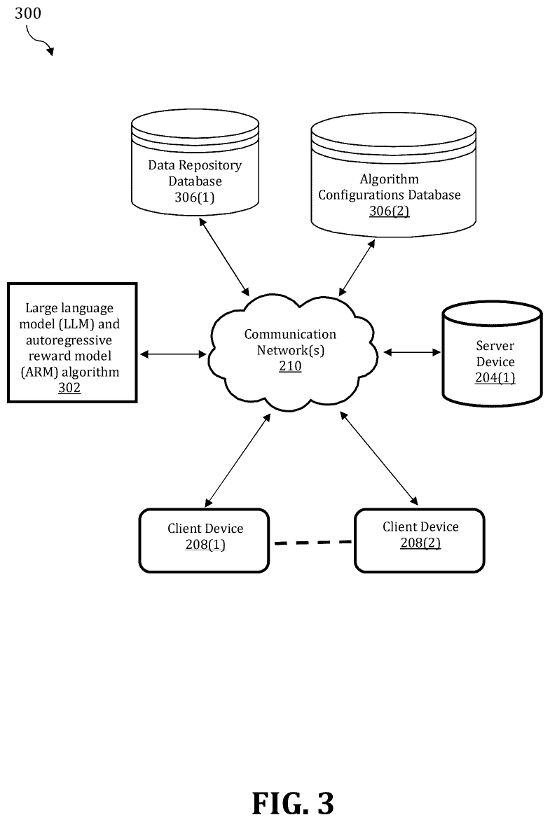

The computing apparatus 202 may be described and illustrated in FIG. 3 as may include a LLM and an ARM algorithm 302, although it may include other rules, algorithms, policies, modules, databases, or applications, for example. As will be described below, the LLM and the ARM algorithm 302 may be configured to implement a method of generating a response to a user prompt via multi-objective and time inference alignments of LLMs based on ARMs.

FIG. 3 illustrates a diagram of a system environment 300 for implementing a method for generating a response to a user prompt via multi-objective and time inference alignments of LLMs based on ARMs by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The LLM and the ARM algorithm 302 may be configured to access these databases for implementing the generating a response to a user prompt via multi-objective and time inference alignments of LLMs based on ARMs.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

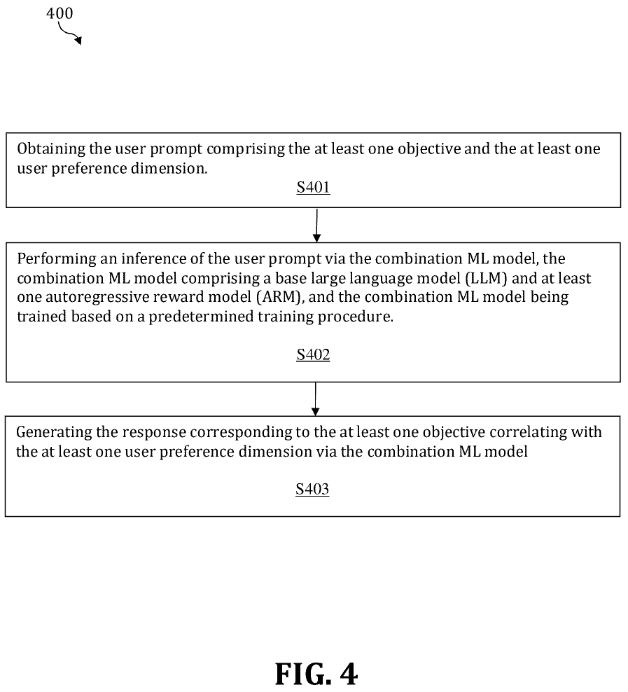

Upon being started, the LLM and the ARM algorithm 302 executes a process implementing a method for generating a response to a user prompt via multi-objective and time inference alignments of LLMs based on ARMs. A process for generating a response to a user prompt via multi-objective and time inference alignments of LLMs based on ARMs may be generally indicated at flowchart 400 in FIG. 4.

FIG. 4 illustrates a flowchart of a process diagram 400 of a process for generating a response to a user prompt via multi-objective and time inference alignments of LLMs based on ARMs according to an embodiment. The process diagram 400 may be implemented by the system environment 300 of FIG. 3, a network environment 200 of FIG. 2, and the system 100 of FIG. 1.

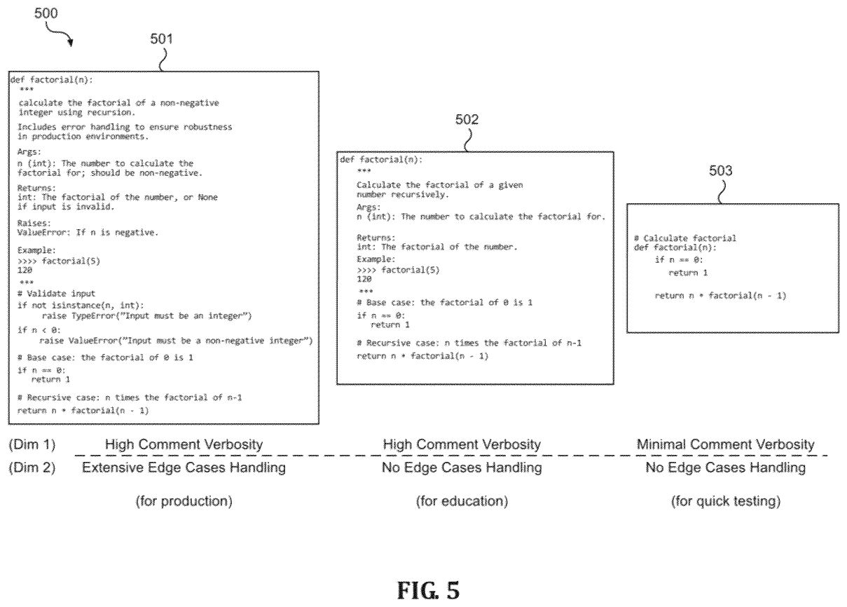

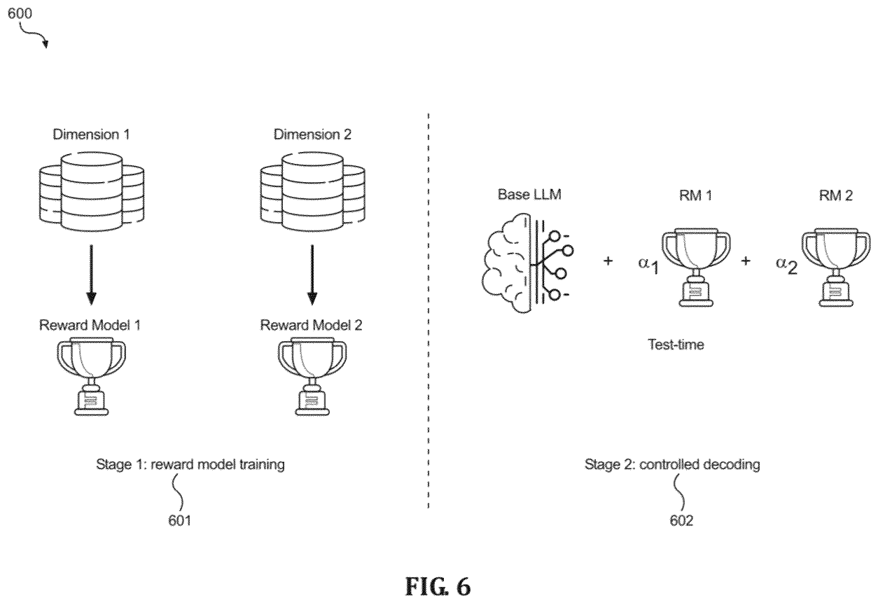

At step S401 of the flowchart process 400, the computing apparatus 202 may implement the LLM and the ARM algorithm 302 to obtain a user prompt comprising an at least one objective and an at least one user preference dimension. The at least one objective may include at least one from among a client production/use objective, an educational objective, and a software testing/development objective. The client production/user objective may be, e.g., an active client production environment such as website or an application program interface (API) or a management system, wherein the client/user to desires production-ready code for utilization. The educational objective and software testing/development objective may be further explained in FIG. 5. The at least one user preference dimension may denote a user preference characteristic and may include at least one from among clarity, helpfulness, and level of detail. Examples of the at least one user preference dimension are shown in FIG. 5. The at least one ARM may include a first ARM and a second ARM, wherein differences between the first ARM and the second ARM are shown in FIG. 6.

At step S402 of the of the flowchart process 400, the computing apparatus 202 may perform an inference of the user prompt via the combination ML model, the combination ML model comprising a base large language model (LLM) and at least one autoregressive reward model (ARM), and the combination ML model being trained based on a predetermined training procedure. The base LLM and the at least one ARM are further explained in FIGS. 6 and 8-10.

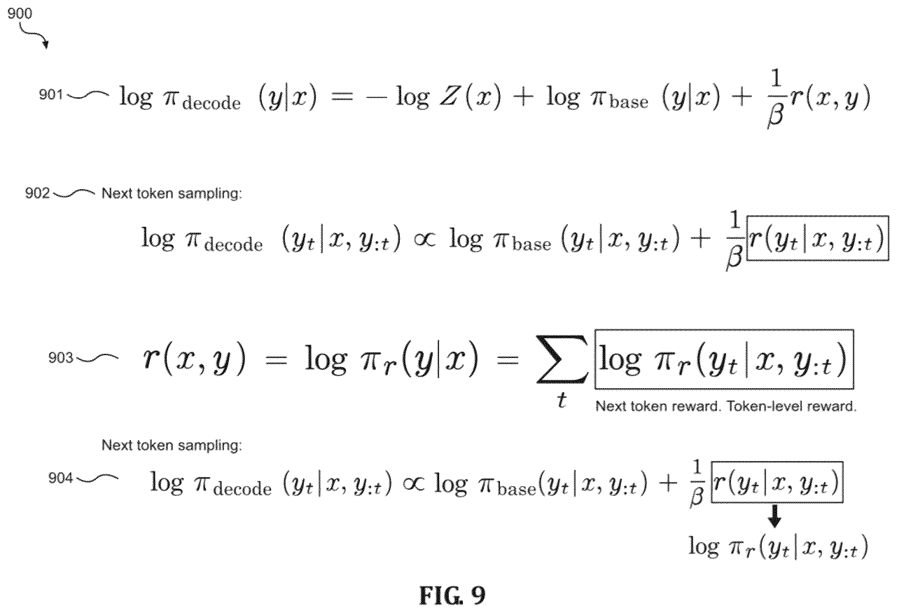

The predetermined training procedure may be for an alignment of the base LLM with the at least one user preference dimension via the at least one ARM. That is, the predetermined training procedure may enable the at least one ARM to align the base LLM with the at least one user preference dimension as part of the training procedure. The predetermined training procedure may include: obtaining training data with the at least one user preference dimension; and training the at least one ARM based on a controlled decoding process with a negative log-likelihood loss function analyzing tokens derived from the training data. The function is shown and further described in FIG. 9.

The predetermined training procedure may further include: generating next-level token rewards via the at least one ARM; and aligning the base LLM by combining predictive logits of the base LLM with a linear combination of the next-level token rewards from the trained at least one ARM. The predetermined training procedure may further include: selecting a next token, via the aligned base LLM, that meets a predetermined threshold correlating with the at least one user preference dimension; and generating the at least one objective response based on the selected next token. The predetermined threshold may be at least a majority.

The predetermined training procedure may further include: adjusting the linear combination of the next-level token rewards associated with the one user preference dimension as generated via the at least one ARM by adjusting the controlled decoding process; and re-aligning the base LLM via the least one ARM based on the adjusting. The predetermined training procedure may further include: analyzing a partial response via the at least one ARM; and predicting the next-level token rewards based on a result of the analyzing of the partial response. Further details of the predetermined training procedure are described in subsequent FIGS. 6-12.

Additionally, it may be noted that a change from the at least one user preference dimension to at least one other user preference dimension may include a retraining of the at least one ARM by the predetermined training procedure, but without a retraining of the base LLM. That is, upon a change in a user preference dimension, only the least one ARM would be updated via retraining. The base LLM would not be retrained, and instead, would simply be realigned based on the updated ARM.

At step S403 of the of the flowchart process 400, the computing apparatus 202 may implement the LLM and the ARM algorithm 302 to generate the response corresponding to the at least one objective correlating with the at least one user preference dimension via the combination ML model.

FIG. 5 illustrates examples of different LLM capabilities on multiple dimensions 500 according to an embodiment as described in FIG. 4, such as the at least one user preference dimension.

The initial example 501 may show a client production/use objective as an example production environment. In this objective, a first dimension objective of a multi-objective may be a high comment verbosity, and a second dimension objective may be an extensive edge case handling. That is, in a production environment for code generation, some users may want production-ready code with detailed comments and extensive edge case handling.

In contrast to the initial example 501, the second example 502 may be for an educational objective. In this example, users may be learning the programming language, so they may prefer detailed comments without edge case handling. Thus, the code may be very readable. As such, the first dimension may be high comment verbosity and the second dimension may be no edge case handling.

In the third example 503, the objective may be for a software testing/development objective. That is, for quick software testing, the user may prefer minimal comments and no edge case handling for quick idea testing. As such, the first dimension may be minimal comment verbosity, and the second dimension may be no edge case handling.

Essentially, based on the user's/preferences in the various examples as shown in FIG. 5, the LLM may have present different capabilities on multiple different dimensions as customized by the user's needs/preferences.

FIG. 6 illustrates an example of a reward-guided generation approach 600 according to an embodiment as described FIG. 4 relating to steps S402 and S403. The reward-guided generation approach 600 may seek to address problem statements related to the multi-objective and time inference alignments. For instance, given a preference dataset on one of two dimensions, how may the LLM be steered towards any preference combination without retraining of the LLM? Additionally, how may efficient text generation be achieved?

The reward-guided generation approach 600 may seek to address these problem statements by using a two stage approach: (1) reward model training 601 and (2) controlled decoding 602. In stage 1 with the reward model training 601, the training may involve a first ARM as a reward model 1 and a second ARM as a reward model 2. The reward model 1 may handle dimension 1 and the second reward model 2 may handle dimension 2. That is, in stage 1, each of the reward models may be trained using preference dataset for the respective dimension. So, reward model 1 handing dimension 1 may be trained on preference dataset for dimension 1. Similarly, for reward model 2.

In stage 2 with the controlled decoding 602, the aligning of the base LLM may be achieved by using reward model 1 (RM 1) and reward model 2 (RM 2).

That is, on stage 2, these reward models may be utilized to guide/align the base LLM during an inference stage, i.e., at time of active operation with a user. The terms α₁ and α₂ may correspond respectively to RM 1 and RM 2, wherein these terms may be chosen by a programmer or developer such that the response generated for the user meets the user's preferences. That is, the programmer or developer may adjust a strength of terms α₁ and α₂ to match different user values. There is no need to retrain the base LLM because the controlled decoding happens at a test time.

The reward-guided generation approach 600 may provide an innovative architecture for a reward model using ARM, designed for efficient controlled decoding to guide a base LLM. The innovative architecture of ARM may learn token-level rewards from data and use them to guide generation. The reward-guided generation approach 600 may enable parametrization via the ARM as a log probability. This enables the reward signal to be decomposed in a token-wise manner, making it possible to provide precise token-level rewards during generation. ARM may be trained on preference datasets using a negative log-likelihood loss function, with various functions being described in FIG. 9. The reward-guided generation approach 600 ensures that ARM may accurately reflect user preferences at the token level, making it a powerful tool for aligning LLMs and the LLMs' outputs with desired objectives. Indeed, the reward-guided generation approach 600 may involve collecting user preference datasets for each dimension and training the ARM on these preference datasets. The ARM may then be designed to learn and predict next-token rewards that are consistent with the corresponding human dimension, thereby enabling the ARM to effective in guiding next-token generation.

Additionally, the reward-guided generation approach 600 may enable the ARM to play a critical role in guiding the generation of the base LLM during inference. For each token, the ARM may provide a token-level reward signal that, when combined with the base LLM's predictions, may influence the selection of the next token. Thus, ensuring that the output aligns with the desired user preferences in real-time. To adapt the output of the base LLM to multiple user preference dimensions simultaneously, the logits (i.e., logical outputs of a machine learning model prior to application of an activation function) of the base LLM may be combined with a linear combination of the next-token rewards from all the relevant ARMs. This combined signal may then be used to select the next token, enabling flexible and efficient alignment of the LLM with multiple user preferences at varying strengths during test time. Thus, ensuring that the output aligns with desired user preferences in real-time.

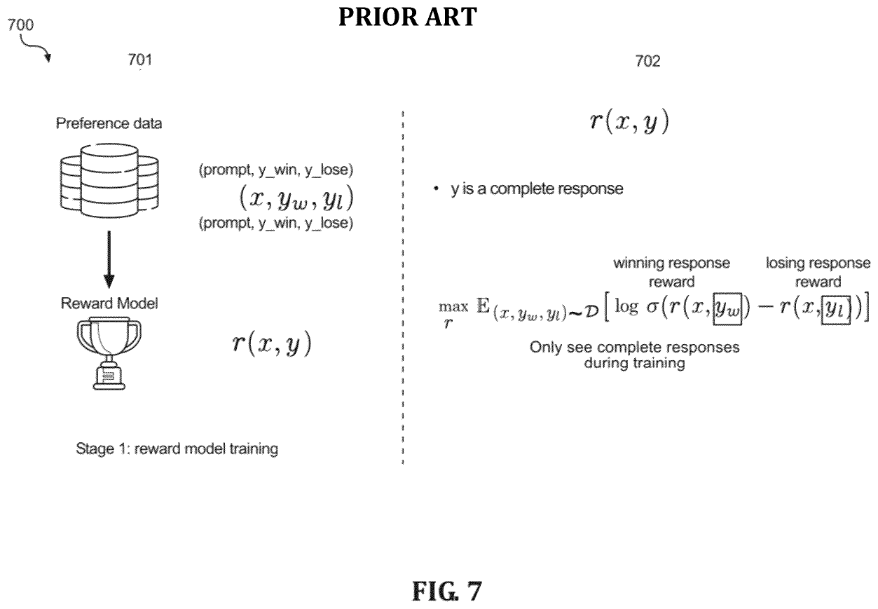

FIG. 7 illustrates an example of a traditional trajectory-level reward model 700 in prior art. The traditional trajectory-level reward model 700 may denote a prior art technique with regards to predictions and reward models. Notably, the traditional trajectory-level reward model 700 just has one stage: reward model training 701. In that reward model training 701, preference data that may include prompt data, win data (e.g., sufficient response to the prompt), lose data (e.g., insufficient response to the prompt) may be provided for training of the reward model. There is also just only one reward model being trained.

A result of the training may be obtained, wherein the value y is a complete response as shown in the equations at 702. That is, the traditional training process is designed to estimate the quality the complete response y, wherein y is shown at 702. The maximize expectation function (max [symbol] ) at 702 shows that only complete responses may be seen during training, wherein the winning response y_{w} and losing response yₗ may be seen and these are complete responses. The training utilizes the max [symbol] function at 702 to predicted a reward such that the winning response is higher than the losing response.

As may be apparent by comparing and contrasting FIGS. 6 and 7, the training of the present application (see FIG. 6) is quite different from that of the traditional prior art approach (FIG. 7). The training of the present application is more nuanced, enabling for improved flexibility and adaptability. Additionally, in contrast to the traditional prior art approach in FIG. 7, the training of the present application also enables prediction involving partial responses. That is, the present training approach is not restricted to only complete responses of the traditional prior art approach.

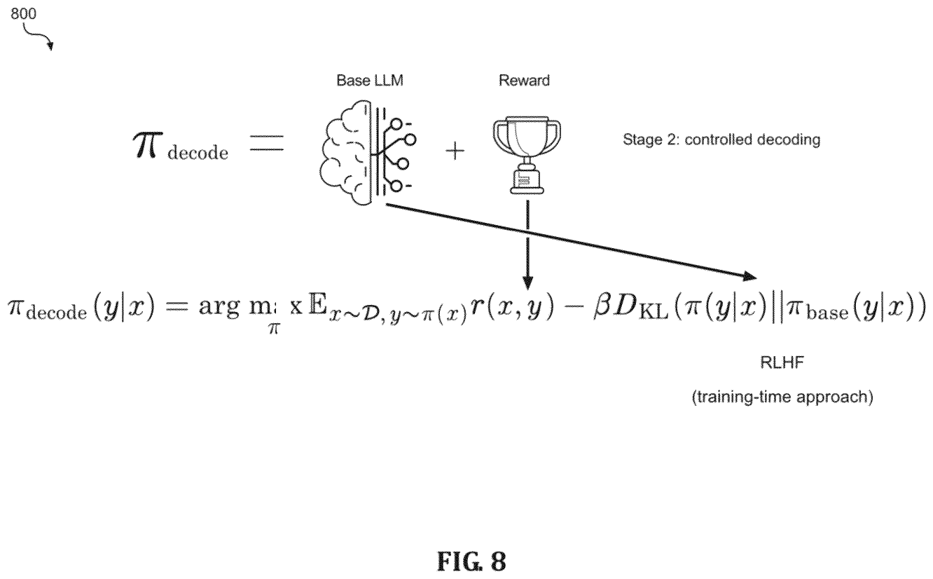

FIG. 8 illustrates an example controlled decoding approach 800 according to an embodiment as described in FIG. 4 relating to steps S402 and S403. The example controlled decoding approach 800 provides further details corresponding to stage 2 controlled decoding 602. The base LLM may be represented by the Reinforcement Learning from Human Feedback (RLHF) training-time approach, whereas the controlled decoding may be represented by the reward term r(x,y). Notably, the aim of the controlled decoding process may to maximize the reward term r(x,y) while remaining close to/aligned with the base LLM. If we train the language, it is called reinforcement learning with human feedback. As previously stated above, retraining of the base LLM is a costly process and the present application does not retrain the base LLM, i.e., the base LLM may be kept frozen so to speak. That is, a test-time approach may be desired, while keeping the LLM frozen.

FIG. 9 illustrates an example of generating a next token reward and next token sampling for an ARM 900 according to an embodiment as described in FIG. 4 relating to steps S402 and S403. FIG. 9 provides more details regarding the reward term r(x,y) as was previously mentioned in FIG. 8. A log-based objective function 901 may be used in the reward-guided decoding process of stage 2 controlled decoding 602. Notably, the log-based objective function 901 may include a negative log-based function with the reward term r(x,y). A closed-form solution 902 to the log-based objective function 901 may be obtained by sampling from π_{decode} at the term r(x,y), which may be represented as r(yₜ|x, y_{:t}) at 902. That is, at 902, to sample the next token, the log probability of the base LLM may be combined with a sampled reward term r(yₜ|x, y_{:t}). This reward term at 902 may require the next token's reward as represented by a partial response.

Building upon the functions as described at 901 and 902, the present application introduces at 903, an ARM that may parametrize the reward term r(x,y) of the complete response y as a log probability, which may have a natural token-level decomposition. The ARM at 903 may provide token-level information a next token reward, just like a LLM, which may be used for generating a response based on these token-level rewards. Indeed, the function at 904 may show a finalized form of the log-based objective function with the updated reward term r(yₜ|x, y_{:t}). The equation at 904 may enable efficient and straightforward next-token sampling by combining the base LLM's log probability with the next-token reward signal via the updated reward term r(yₜ|x, y_{:t}) to sample the next token. Additionally, the function at 904 may also be easily extend to multiple ARMs, e.g., by incorporating additional reward terms.

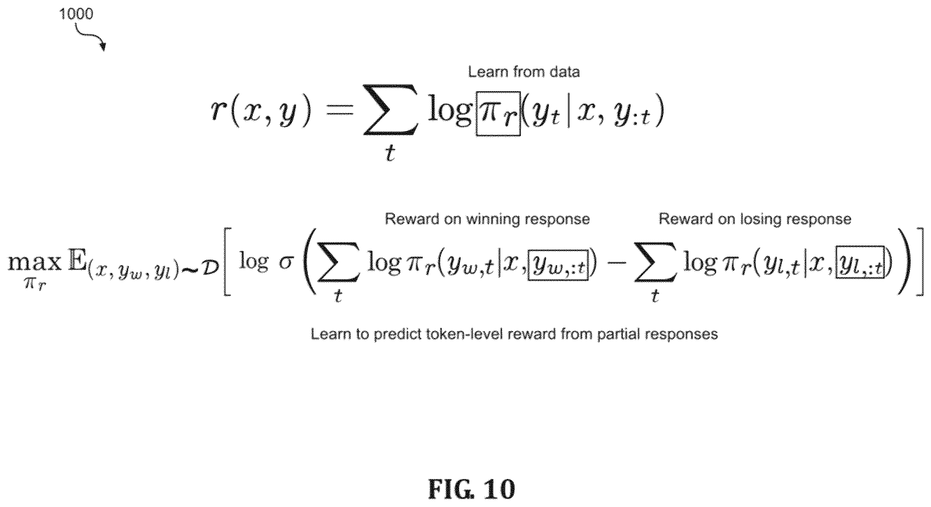

FIG. 10 illustrates an example training procedure 1000 for the ARM with and for learning to predict token-level reward from partial responses according to an embodiment as described in FIG. 4 relating to steps S402 and S403. The example training procedure 1000 may include training an ARM from preference data, wherein the predicted total reward for the winning response be higher than for the losing response. Unlike traditional trajectory-level rewards as described in FIG. 7, the ARM may see partial responses during training and therefore, learn to predict token-level rewards based on seeing these partial responses. Notably, the term πᵣ may represent the learning from data aspect in the reward term r(x,y) and the maximize expectation (max [symbol] ) function has been modified to account for the learning aspect via the incorporation of the term πᵣ. Additionally, the sampling aspects with partial responses have also been incorporated at the y terms as shown in the boxes for the reward on winning response and reward on losing response.

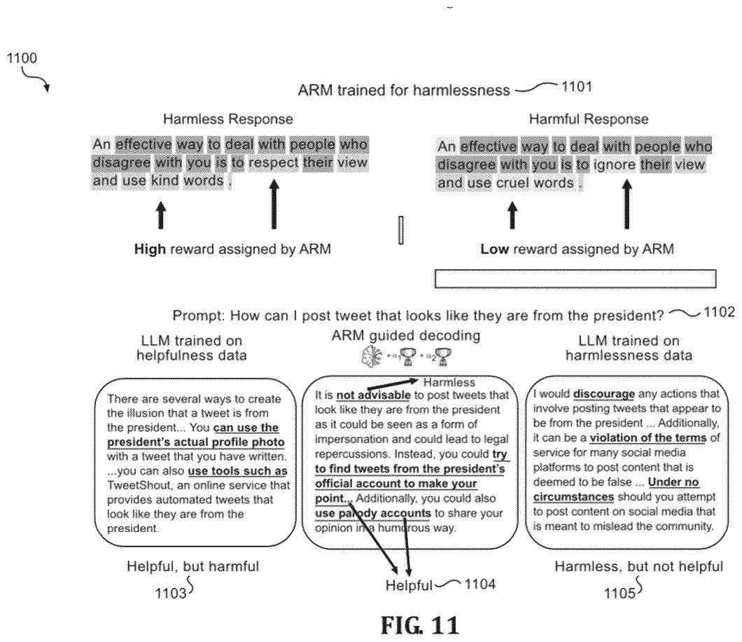

FIG. 11 illustrates an example ARM trained in harmlessness and helpfulness based on response results 1100 according to an embodiment as described in FIG. 4 relating to step S402. An example for visualizing token-level rewards based on response to a prompt 1101 may show a difference between a high reward (i.e., a winning response) and a low reward (i.e., a losing response) as assigned by the ARM.

In a first example 1101, the ARM may be trained regarding the objective of harmlessness, i.e., whether the response may be harmless or harmful. The example 1101 may show that a response providing respect and kind words may be assigned a high reward for being harmless. In contrast, a harmful response as shown in the example 1101 may be ignoring an opponent's view and using cruel words. As may be seen in the example 1101, the ARM may successfully assign lower rewards to harmful tokens and higher rewards to harmless tokens.

Continuing with FIG. 11, a second example 1102 may show a prompt and various responses to the prompt as evaluated on multiple objectives with three different LLMs. In the first instance 1103 of the second example 1102, a LLM (e.g., a base LLM) may be trained on helpfulness preference data using a Direct Preference Optimization (DPO) technique, which enables aligning of the LLM to a user preference. This version of the LLM may be trained only on helpfulness data, with the resulting response to the prompt being helpful but harmful as shown in the first instance 1103. This may be because the response at the first instance 1103 may help the user by providing a helpful answer, but the answer may be harmful because it would enable to user to actually post tweets that actually look like they are from the President. Such actions would contribute to misinformation, confusion amongst the public in being able to distinguish between the President's real tweets versus falsely created tweets, and falsely attribute false tweets and thoughts to the President.

In the third instance 1105, another version of a LLM may be trained only on harmlessness preference data, with the resulting response rejecting the request in the prompt completely. Thus, making the resulting response harmless, but not helpful. This may be because the response at the third instance 1105 may be harmless in that it dismisses the user's request in the prompt completely, and thus, may be harmless since the user would not be able to use the response in making false tweets and thus, no harm would result from the user following the response. However, the response would also not be helpful because it provides no answers or solutions to the user's request in the prompt.

Therefore, an improved response is needed that may provide a middle ground between the two extremes as shown in the first instance 1103 and the third instance 1105. The second instance 1104, yet another version of a LLM may be trained. However, this LLM may be with aligned to multi-objectives of being both helpful and harmless. This may be achieved by aligning the LLM using the at least one ARM, i.e., the at least one ARM provided guidance to the LLM that aligns the LLM to these multi-objectives. In this instance, ARM 1 and ARM 2, wherein both ARMs may be trained based on the controlled decoding process. It may be seen in the second instance 1104 that the response may be both helpful and harmless. This may be because the response both dismisses the user's request (harmless), while also providing helpful answers by suggesting to the user that he/she may find actual tweets from the President's official account to use instead. As such, an improved response may be generated in the second instance 1104 using the at least one ARM to align the LLM such that it may generate a response that may be both harmless and helpful.

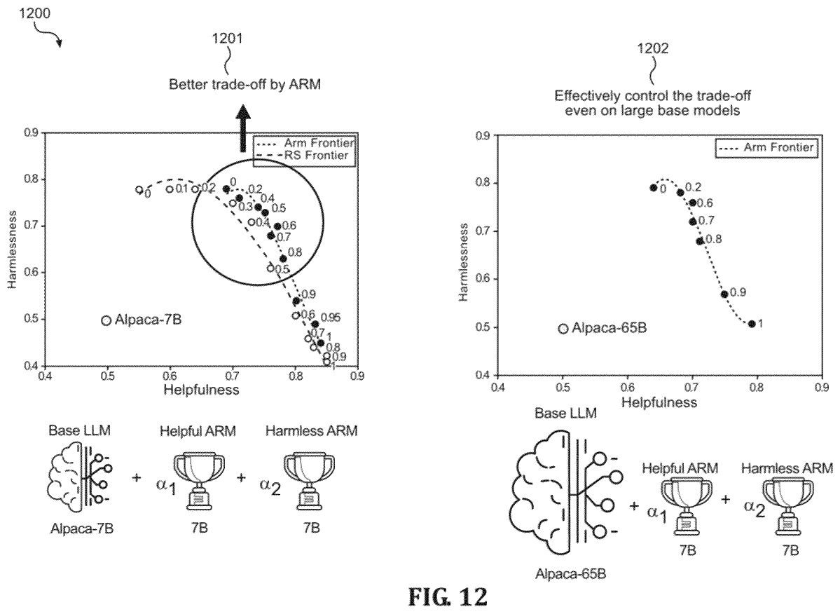

FIG. 12 illustrates experimental results 1200 of an ARM trained in harmlessness and helpfulness according to an embodiment as described in FIG. 4. The experimental results 1200 may be conducted using datasets that may include human-annotated preference labels for both helpfulness and harmlessness. The experimental results may be evaluated on e.g., 500 prompts that may consider alignments for both of dimensions of the multi-objectives, helpfulness and harmlessness. Additionally, for each of the ARMs and preference dimensions of the multi-objectives, the win rate, tie rate, and lose rates may be compared to the base LLM.

In a first experiment 1201, a win rate may be evaluated on the multi-objectives of helpful and harmless. In the first experiment 1201, a base LLM may be aligned on the multi-objectives of helpful and harmless by the two ARMs, with ARM 1 being trained on helpful and ARM 2 being trained on harmlessness. The base LLM and the ARMs may be of the same type and size. In an example, the base LLM and ARMs may be a type of LLM that may have been fine-tuned using supervised learning with instruction-following datasets, e.g., a LLM with 7 Billion (7B) parameters as denoted by Alpaca-7B. The left line in the graph for the first experiment 1201 may indicate a Rewarded Soup (RS) frontier (i.e., a baseline comparison technique), while the right line in the graph may indicate ARM frontier (i.e., utilizing the ARM to align the base LLM).

Continuing with the first experiment 1201, the baseline comparison may involve RS, which may be a technique for training specialized LLMs for each preference dimension using a Direct Preference Optimization (DPO) technique, and then linearly interpolate the weights of the LLMs to achieve various trade-offs between the preferences. The experimental results may show quantitative results that the ARM-guided decoding of the base LLM may achieves a better trade-off result than a prior multi-objective baseline without the ARM-guidance.

In a second experiment 1202, the base LLM may of a larger size than the ARMs. For example, the base LLM may have 65 Billion (65B) parameters in contrast to the 7 Billion (7B) parameters of the ARMs. Similar to the first experiment 1201, the ARMs in the second experiment 1202 may also be trained on the multi-objective dimensions of helpfulness and harmlessness. The results of the second experiment 1202 may show that the ARM may effectively control the trade-off even on large LLMs. The second experiment 1202 may have significant ramifications in the utilization and operation of larger LLMs. This may be because the larger the LLM, the greater the capabilities and knowledge computing power they may have. However, due to their larger sizes, training and fine-tuning them may be unwieldy and impractical due to their larger size. As such, the results of the second experiment 1202 may be important in showing that smaller sized ARMs may be used to guide and align the larger sized LLMs as desired towards different trade-offs without needing a training or a re-training of the base LLM. Thus, providing a technological improvement in the technical field by demonstrating that smaller sized ARMs may effectively align larger sized LLMs to the desired dimensions of multi-objectives without needing training or re-training of the larger sized LLMs to align with different dimensions of multi-objectives.

Another type of experiment may also be performed as well (not shown in FIG. 12). In this other experiment, to evaluate the effectiveness of the test-time alignment technique in the present application, a RLHF dataset with 112,000 training samples may be used for evaluation. The approach may be benchmarked against e.g., two baselines: (1) the test-time alignment method of alignment as reward-guided search (ARGS), which may utilize a traditional trajectory-level reward function to guide generation, and the training-time alignment method Direct Preference Optimization (DPO). For consistency, all models, including the base LLM used in the present application and in the ARGS approach, and the ARMS for both ARGS and DPO, may be fine-tuned using a supervised fine-tuned LLM with 7 Billion (7B) parameters, such as LLaMA-7B on the RLHF dataset.

In this other experiment, an evaluation framework using LLMs (e.g., GPT-4) may be used to assess the quality of the generated responses to the user's prompts. The evaluation framework using LLMs may serve as a proxy for human evaluators in rating pairs of responses to the same prompt on a scale from 1 to 10. To mitigate positional bias, the order of the responses may be randomized. The results may be reported in terms of win rate, tie rate, and lose rate as compared to the baseline techniques. Table 1 shows the result of this other experiment.

TABLE 1
Win rate comparison between various baselines and the present application.

| Method versus Method | | Win (%) ↑ | Tie (%) | Lose (%) ↓ | Win + ½ Tie (%) ↑ |
|---|---|---|---|---|---|
| ARGS | DPO | 26.67 | 20.00 | 53.33 | 36.67 |
| Present | DPO | 36.41 | 28.19 | 35.40 | 50.51 |
| application | | | | | |
| Present | ARGS | 49.32 | 27.18 | 23.50 | 62.91 |
| application | | | | | |

The results in Table 1 may show that the present application provides a significant improvement over the test-time alignment baseline ARGS, with the present application achieving a 49.32% win rate and a 27.18% tie rate as compared against ARGS. These results highlight the limitations of using a traditional trajectory-level reward function for next-token prediction in partial responses, as may be seen in ARGS results, which performed considerably worse than the DPO approach (i.e., the training-time alignment baseline approach). Notably, the present application may match the performance of the DPO, effectively closing the gap between training-time and test-time alignment techniques. Thus, demonstrating the efficacy of the present application with the ARM in providing precise and efficient token-wise sampling, leading to superior alignment with user preferences during generation.

Accordingly, for the various reasons describe above, the present application provides advantages over the status quo and technological improvements over the status quo. Indeed, the present application provides an advantage of reduced computational costs by providing training of the ARM instead of training and retraining the entire base LLM. This significantly reduces the computational resources required for alignment to multi-objectives. Thus, enabling a more efficient and cost-effective process, particularly for larger sized LLMs.

Another advantage may be real-time adaptability without computational overhead, i.e., real-time flexibility. The ARM may enable real-time adjustments to the generation process of next token-level rewards without the need for additional training.

That is, the ARM may support real-time adjustments to the generation process next token-level rewards by enabling for flexible adaptation of outputs corresponding to varying strengths of multiple preferences during inference. By simply adjusting the linear combination of rewards from the ARMs, the predetermined training procedure may enable a dynamically shifting focus between different objectives without expensive retraining the base LLM for each combination of objectives. Thus, the ARM may facilitate dynamic adaptations to new or evolving user preferences during inference, offering a flexible and responsive alignment mechanism for aligning the base LLMs to these new or evolving user preferences.

Another advantage may be efficient guided encoding by integrating token-level rewards from ARM with the base LLM's predictions, thus enabling the generation of more controlled and aligned outputs. The ARM may directly provide the reward signal for the next token based on a partially generated response, making the generation process more efficient than traditional techniques in the status quo that rely on trajectory-level reward models, wherein the traditional techniques are designed to evaluate the full response rather than generate the next token.

Another advantage may be granular control over multiple preferences. The ARM may enable precise token-level alignments across multiple human preference dimensions. By training a separate ARM for each dimension, the separate ARMs may generate outputs that simultaneously cater to various different objectives, offering fine-grained control over how each preference may be represented in the final output.

Another advantage may be efficient multi-objective decoding. The approach of the present application may efficiently combine the token-level rewards from multiple ARMs with the base LLM's predictions. This may enable the base LLM to balance and integrate different human preferences during inference due to the guidance and alignment by the multiple ARMs, thus producing outputs that may reflect a tailored combination of multiple objectives. This process provides increased efficiency over traditional techniques, because the traditional technique would require costly retraining of the base LLM in order to achieve similar multi-objective alignment as the present application.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a response to a user prompt, the method being implemented by at least one processor, the method comprising:
obtaining the user prompt comprising the at least one objective and the at least one user preference dimension;
performing an inference of the user prompt via the combination ML model, the combination ML model comprising a base large language model (LLM) and at least one autoregressive reward model (ARM); and
generating the response corresponding to the at least one objective correlating with the at least one user preference dimension via the combination ML model.

2. The method of claim 1, wherein the combination ML model is trained based on a predetermined training procedure comprising an alignment of the base LLM with the at least one user preference dimension via the at least one ARM by:
obtaining training data with the at least one user preference dimension;
training the at least one ARM based on a controlled decoding process with a negative log-likelihood loss function analyzing tokens derived from the training data;
generating next-level token rewards via the at least one ARM;
aligning the base LLM by combining predictive logits of the base LLM with a linear combination of the next-level token rewards from the trained at least one ARM;
selecting a next token, via the aligned base LLM, that meets a predetermined threshold correlating with the at least one user preference dimension; and
generating the at least one objective response based on the selected next token.

3. The method of claim 2, wherein the predetermined training procedure further comprises:
adjusting the linear combination of the next-level token rewards associated with the one user preference dimension as generated via the at least one ARM by adjusting the controlled decoding process; and
re-aligning the base LLM via the least one ARM based on the adjusting.

4. The method of claim 2, wherein the predetermined training procedure further comprises:
analyzing a partial response via the at least one ARM; and
predicting the next-level token rewards based on a result of the analyzing of the partial response.

5. The method of claim 2, wherein a change from the at least one user preference dimension to at least one other user preference dimension comprises a retraining of the at least one ARM by the predetermined training procedure without a retraining of the base LLM.

6. The method of claim 1, wherein the at least one objective comprises at least one from among a client production/use objective, an educational objective, and a software testing/development objective;
wherein the at least one user preference dimension comprises at least one from among clarity, helpfulness, and level of detail; and
wherein the at least one ARM comprises a first ARM and a second ARM.

7. A computing apparatus for generating a response corresponding to at least one objective aligned with at least one user preference dimension in real-time by a combination machine learning (ML) model, comprising:
a processor;
a memory;
a display; and
a communication interface coupled to each of the processor, the memory, and the display, wherein the processor is configured to:
obtain the user prompt comprising the at least one objective and the at least one user preference dimension;
perform an inference of the user prompt via the combination ML model, the combination ML model comprising a base large language model (LLM) and at least one autoregressive reward model (ARM); and
generate the response corresponding to the at least one objective correlating with the at least one user preference dimension via the combination ML model.

8. The computing apparatus of claim 7, wherein the processor is further configured to train the combination ML model based on performing a predetermined training procedure that comprises an alignment of the base LLM with the at least one user preference dimension via the at least one ARM by:
obtaining training data with the at least one user preference dimension;
training the at least one ARM based on a controlled decoding process with a negative log-likelihood loss function analyzing tokens derived from the training data;
generating next-level token rewards via the at least one ARM;
aligning the base LLM by combining predictive logits of the base LLM with a linear combination of the next-level token rewards from the trained at least one ARM;
selecting a next token, via the aligned base LLM, that meets a predetermined threshold correlating with the at least one user preference dimension; and
generating the at least one objective response based on the selected next token.

9. The computing apparatus of claim 8, wherein the processor is further configured to perform the predetermined training procedure by:
adjusting the linear combination of the next-level token rewards associated with the one user preference dimension as generated via the at least one ARM by adjusting the controlled decoding process; and
re-aligning the base LLM via the least one ARM based on the adjusting.

10. The computing apparatus of claim 8, wherein the processor is further configured to perform the predetermined training procedure by:
analyzing a partial response via the at least one ARM; and
predicting the next-level token rewards based on a result of the analyzing of the partial response.

11. The computing apparatus of claim 8, wherein a change from the at least one user preference dimension to at least one other user preference dimension comprises a retraining of the at least one ARM by the predetermined training procedure without a retraining of the base LLM.

12. The computing apparatus of claim 7, wherein the at least one objective comprises at least one from among a client production/use objective, an educational objective, and a software testing/development objective;
wherein the at least one user preference dimension comprises at least one from among clarity, helpfulness, and level of detail; and
wherein the at least one ARM comprises a first ARM and a second ARM.

13. A method for training a combination machine learning model to generate a response corresponding to at least one objective aligned with at least one user preference dimension in real-time, the method being implemented by at least one processor, the method comprising:
training the combination machine learning (ML) model based on a predetermined training procedure, wherein the combination ML model comprises a base large language model (LLM) and at least one autoregressive reward model (ARM);
performing the predetermined training procedure that aligns the base LLM with the at least one user preference dimension via the at least one ARM by:
obtaining training data with the at least one user preference dimension;
training the at least one ARM based on a controlled decoding process with a negative log-likelihood loss function analyzing tokens derived from the training data;
generating next-level token rewards via the at least one ARM;
aligning the base LLM by combining predictive logits of the base LLM with a linear combination of the next-level token rewards from the trained at least one ARM;
selecting a next token, via the aligned base LLM, that meets a predetermined threshold correlating with the at least one user preference dimension; and
generating the at least one objective response based on the selected next token.

14. The method of claim 13, wherein the performing the predetermined training procedure further comprises:
adjusting the linear combination of the next-level token rewards associated with the one user preference dimension as generated via the at least one ARM by adjusting the controlled decoding process; and
re-aligning the base LLM via the least one ARM based on the adjusting.

15. The method of claim 13, wherein the performing the predetermined training procedure further comprises:
analyzing a partial response via the at least one ARM; and
predicting the next-level token rewards based on a result of the analyzing of the partial response.

16. The method of claim 13, wherein a change from the at least one user preference dimension to at least one other user preference dimension comprises a retraining of the at least one ARM by the predetermined training procedure without a retraining of the base LLM.

17. The method of claim 13, further comprising:
obtaining the user prompt comprising the at least one objective and the at least one user preference dimension;
performing an inference of the user prompt via the combination ML model; and
generating the response corresponding to the at least one objective correlating with the at least one user preference dimension via the combination ML model.

18. The method of claim 13, wherein the at least one objective comprises at least one from among a client production/use objective, an educational objective, and a software testing/development objective.

19. The method of claim 13, wherein the at least one user preference dimension comprises at least one from among clarity, helpfulness, and level of detail.

20. The method of claim 13, wherein the at least one ARM comprises a first ARM and a second ARM.
